(19) United States
(12) Patent Application Publication
(10) Pub. No.: US 2009/0155568 A1
(43) Pub. Date: Jun. 18, 2009

(54) PLASTIC LATTICE SHEETS AND METHOD OF MANUFACTURE

(76) Inventor: Ronald D. ERWIN, Fayetteville, GA (US)

Correspondence Address: GARDNER GROFF GREENWALD & VILLANUEVA. PC, 2018 POWERS FERRY ROAD, SUITE 800, ATLANTA, GA, 30339, US

(21) Appl. No.: 12/337,377

(22) Filed: Dec. 17, 2008

Related U.S. Application Data
(60) Provisional application No. 61/014,639, filed on Dec. 18, 2007.

(51) Int. Cl. B29C 47/06

(52) U.S. Cl. 428/319.9; 264/153

(57) ABSTRACT

An extruded plastic lattice sheet, and method of making the same, the plastic lattice including a perforated sheet of plastic resin formed from an extruded sheet of plastic resin having been die punched to remove portions of plastic resin leaving a crisscross pattern. The outer surface of the perforated sheet is embossed with a wood grain effect and has a substantially three-dimensional-like appearance of slats formed by an embossing step. Both single-layer and multi-layer lattice sheet is disclosed.

### PRIORITY DATA AND CROSS-REFERENCE TO RELATED APPLICATION

The present application claims priority to provisional application 61/014,639 filed Dec. 18, 2007.

### TECHNICAL FIELD

The present invention relates generally to a system and method of manufacturing plastic lattice sheets, and in particular to a system and method of manufacturing plastic lattice sheets for use as fencing components.

### BACKGROUND OF THE INVENTION

Outdoor fencing, deck products, and backyard concealment products have often been made of wood. In particular, it has been known in the art to make a privacy lattice of interwoven strips of wood to create a criss-cross pattern or grid of wood slats, leaving some small openings therein. Such a lattice is attractive, but tends to need chemical treatment (pressure treatment), stain or paint to preserve the wood against decay by exposure to weather. In recent years, plastic/resin has emerged as a material sometimes used to manufacture a lattice.

Due to the unique appearance of a privacy lattice, making the lattice out of plastic/resin presents something of a challenge. Because the product is a complex three-dimensional shape that varies in depth over its length and breadth, it has been heretofore considered that the lattice product is generally unsuitable for extrusion. Instead, when made of plastic/resin, lattice products are normally injection molded. Oftentimes, the lattice product is provided in large sheets (4 feet by 8 feet), requiring a mold of considerable size and expense. Moreover, injection molding is by its very nature a batch process, which can be relatively low speed.

Accordingly, it can be seen that a need remains in the art for a plastic/resin lattice product and method of manufacture of the same that provides an attractive lattice appearance, can be manufactured at relatively high rates, and which is economical. It is to the provision of such that the present invention is primarily directed.

### SUMMARY OF THE INVENTION

In a first preferred form the present invention comprises an extruded plastic lattice sheet including a perforated sheet of plastic resin formed from an extruded sheet of plastic resin having been die punched to remove portions of plastic resin leaving a criss-cross pattern. The outer surface of the perforated sheet is embossed with a wood grain effect. Moreover, preferably the outer surface of the perforated sheet has an appearance substantially that of crisscross slats.

Preferably, the substantially criss-cross appearance of slats on the outer surface of the perforated sheet is formed by an embossing step.

In one preferred form, the substantially criss-cross appearance of slats on the outer surface of the perforated sheet comprises slat-like portions of the plastic lattice sheet appearing to be interwoven with other slat-like portions of the plastic lattice sheet.

Preferably, the plastic resin comprises high-density polyethylene. Optionally, the perforated sheet comprises an inner layer and first and second outer layers, wherein layers are all formed by extrusion, and wherein the density of the inner layer is lower than the density of the outer layers. Also optionally, the inner layer is foamed to reduce weight and cost.

Optionally, the inner layer is made with a lower cost material per volume than the outer layers. This can be accomplished by foaming and/or by the addition of fillers and/or extenders or by using recycled or off-spec resin.

Advantageously, in a second preferred form the present invention provides a method of manufacturing a plastic fence component having a lattice-like appearance. The method includes the steps of extruding a sheet of plastic resin through a flat sheet die, cutting the extruded sheet of plastic resin to a desired length, die punching the cut sheet of plastic resin to remove portions of plastic resin, and embossing the cut sheet of plastic resin to impart an appearance of slats and wood grain. Preferably, the plastic resin is high-density polyethylene. Also preferably, the mixture comprises equal parts of prime plastic resin, recycled plastic resin, and the additive, which can be calcium carbonate, wood flour, foaming agents or other additives.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

FIG. 1 is block diagram schematic representation of a manufacturing system according to an example embodiment of the present invention.

FIG. 2 is a side sectional view of a portion of a finished lattice section according to the manufacturing system of FIG. 1.

FIG. 3 is a side sectional view of a portion of a finished lattice section according to an alternative embodiment according to the manufacturing system of FIG. 1.

FIG. 4A is a close-up, detailed front view of a portion of a sheet of lattice made according to a preferred form of the invention.

FIG. 4B is a close-up, detailed front view of a portion of a sheet of lattice made according to a second preferred form of the invention.

FIG. 4C is a close-up, detailed front view of a portion of a sheet of lattice made according a third preferred form of the invention.

### DETAILED DESCRIPTION

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

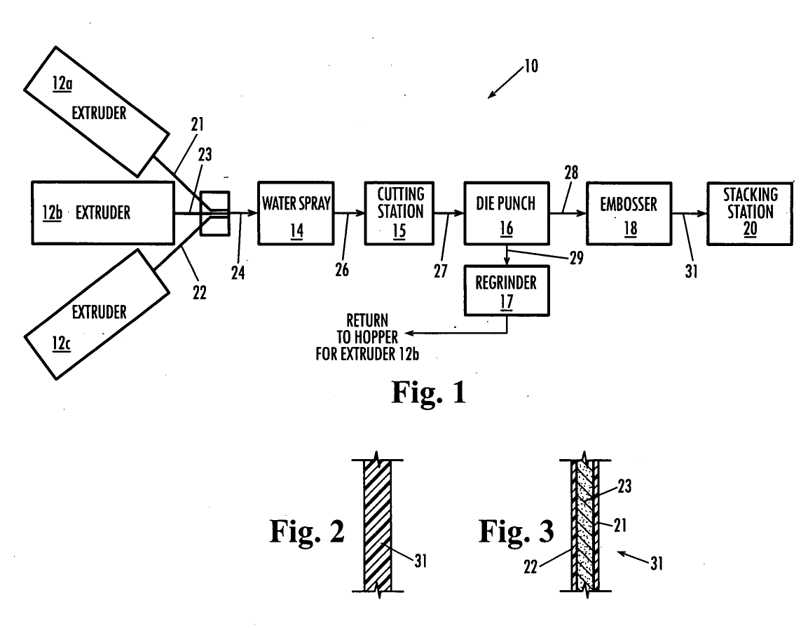

FIG. 1 depicts a manufacturing system 10 for continuously extruding perforated sheets of plastic lattice panels according to an example embodiment of the present invention. As depicted herein, in a preferred exemplary form the manufacturing system 10 includes three extruders 12a, 12b, and 12c for collectively extruding the perforated sheet. In this regard, the extruders are ganged so that their outputs are laminated through a single die head 13 to produce a single sheet of plastic resin for delivery to a water spray cooling station 14. By using multiple extruders in a ganged fashion like this, an extruded sheet with non-homogeneous composition can be provided. In particular, as shown in FIG. 3, a lattice sheet with outer layers 21, 22 and an inner layer 23 can be obtained, with the outer layers having a different composition than the inner layer. Alternatively, one of the extruders 12a, 12b, 12c can be operated singly to produce a homogeneous sheet 31 as depicted in FIG. 2. Alternatively, if a homogeneous sheet is to be produced at all times, the three extruders 12a, 12b, 12c can be replaced with a single extruder so as to minimize capital expenditures.

The extruder(s) is (are) used to melt-mix a plastic composition which forms the sheets (or panels) of lattice. For example, roughly equal parts of prime (virgin) plastic resin, recycled plastic resin, and additives (e.g., filler or extender material) can be fed into the extruders 12, where the resins and additives are plasticated into a melt. Preferably, high-density polyethylene (HDPE) resins are used, although those skilled in the art will understand that other suitable plastic resins can be employed as well. As will be discussed further below, some regrind plastic can be recovered and fed into the central extruder 12b.

Suitable additives can include calcium carbonate and wood flour; although those skilled in the art will understand that other suitable additives can be employed. In a typical commercial embodiment, 50 parts of prime HDPE, 50 parts of recycled HDPE, and 50 parts of calcium carbonate are melt-mixed together in the extruders 12a-12c. Alternatively, the amounts of prime HDPE, recycled HDPE and calcium carbonate may vary. Optionally, foaming agents are added to the composition fed into extruder 12b to reduce the density of the resulting extruded material 23 emanating therefrom. In addition or as an alternative, off-spec resin can be employed.

The extruders, which are generally well known in the art, each include a heated barrel with an internal rotating screw that pumps the melted composition. Here, the melt is forced through a flat sheet die (not shown), which also is generally well known to those skilled in the art. Preferably, the flat sheet die has a slot that is sized to produce an extruded sheet that is typically four feet wide and up to one inch thick. Moreover, in using multiple extruders as depicted, the collective lattice sheet output of the extruders need not exceed about one or two inches of thickness or so, as the thickness of a lattice sheet often will be less than about an inch or so. Those skilled in the art will understand that these dimensions are exemplary and can vary in other embodiments or as needed.

As depicted in FIG. 1, the three sheets of extruded plastic are shortly passed through a subsequent laminating die to unitize the three sheets into a single sheet 24. This sheet 24 of extruded plastic exits the flat sheet die 13 in a semi-viscous state. The sheet 24 of plastic passes over a series of rollers (not shown), which serve both to advance the sheet to a water spray cooling station 14 and to allow the sheet of plastic to begin to cool. Typically, the sheet may be cooled to 150 degrees Fahrenheit or so, although other somewhat cooled temperatures can be attained as needed or appropriate. The now somewhat cooled sheet 26 of plastic is then fed to the cutting station 15 where the extruded sheet 26 is cut to length (typically 6 or 8 feet long), although those skilled in the art will understand that the lengths of the panels can vary in other embodiments. The cutting station 15 preferably employs a flying cut-off saw or a press-driven shear to cut the extruded sheet into cut-length panels 27.

The cut-length panels 27 are then fed to a die punch station 16, which in turn die punches out a series of generally diamond-shaped openings to form a lattice pattern in the cut panels. In alternative embodiments, the length cutting and the die punching could occur at a single station. Thus, the functions of the die punch/cutting stations 15, 16 can be broken up into separate functions performed at different stations and times or can be combined. The cooled sheet 26 can be dried prior to delivery to the cutting station 15 (or prior to delivery to the die punching station 16) by the use of forced air to blow the moisture off the sheet or resilient squeegees to wipe off the moisture.

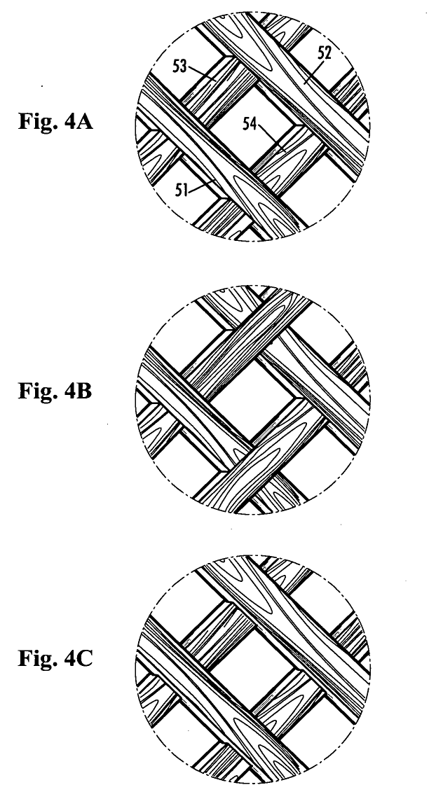

The now die-cut sheet or panel 28 of plastic travels along the series of rollers to an embossing station 18. The embossing station 18 presses select portions of the plastic sheet between embossing dies with great force so that the resulting plastic takes on the appearance of woven or overlaid wooden slats in a lattice pattern. The slats are embossed in a manner to give the appearance that the slats crisscross (such as by appearing to be interwoven or overlaid—see FIGS. 4A and 4B). The embossing dies of the embossing station 18 optionally are heated or cooled as desired to attain a good operating temperature to facilitate the embossing. This can be accomplished with electric heating elements, with water cooling jackets, or with other techniques.

Alternatively, the embossing and or the punching/cutting can be used to impart a slightly three-dimensional aspect to how the slats appear to crisscross. In this regard, a slat can have a slightly lower upper surface compared to the adjacent slat (which is oriented transversely thereto). This is depicted in FIG. 4C. The slats of the sheet alternatively stand slightly proud of other slats on the sheet to create a three-dimensional appearance in the surface of the lattice sheet.

Additionally, the embosser 18 imparts a wood grain surface texture on the upper (front) surface of the plastic sheet, giving it the appearance of wood grain (in pattern at least). The embosser 18 optionally can be employed to smooth burrs resulting from the die punching and cutting operation. In alternative embodiments, the punching, cutting and embossing can be combined into a single step at a single, appropriately designed station.

While the die-cut panels 28 travel on to the embosser, the punched-out waste pieces and any other trimmings 29 from the die punching station 16 are fed to a material grinder 17 where the pieces and trimmings are ground up into a relatively small size and then fed to an unshown hopper for refeeding to the central extruder 12b. Thus, the reground plastic gets incorporated into the melt of the center layer, without affecting the composition of the outer layers. In this way, material waste is kept very low and the lattice sheets or panels can be made very economically, while still ensuring high quality material composition for the external layers.

The die-cut, embossed plastic sheet 30 next travels along the series of rollers to a stacking station 20, where the plastic sheets are stacked for packaging and shipping. Optionally, at this stacking station 30, water can be used to cool the die-cut, embossed sheets. Alternatively or in addition, forced air can be used to cool and/or dry the sheets. Also, in some applications no additional cooling need be applied to the sheet 20 and the sheets can be simply stacked at the stacking station 30 and packaged for shipment.

As depicted in FIG. 3, the die-cut sheet 30 of plastic lattice preferably comprises an inner layer 23 and first and second outer layers 21, 22. The density of the inner layer 23 is preferably considerably lower than the density of the outer layers 21, 22. In one embodiment, the low-density inner layer 23 is produced with the use of a foaming agent. As foaming agents for use in foaming plastic/resin are well-known in the art, no further description of the foaming agent is needed here. By making the inner layer 23 to have a relatively low density, the sheet 30 of plastic lattice can have a substantial thickness while still minimizing weight. Thus, a relatively light-weight plastic lattice sheet can be obtained by foaming the inner layer. The outer layers retain the strength to hold and maintain the desired detail and overall shape, while the low-density inner layer lowers the overall weight.

In an alternative embodiment, the inner layer is made with a lower cost material per volume than the outer layers. For example, the outer layers can be made with a UV-stabilized plastic, while the inner layer is not. Also, the outer layers can be made from prime or virgin plastic, while the inner layer is made from recycled plastic, regrind plastic or other low-cost material. Also, the outer layers can be made of plastic whose color is carefully controlled, while the inner layer is made from plastic that happens to be available, independent of color (including off-spec resins). Likewise, the outer layers can be made from premium plastic material, while the inner layer is made from lower cost materials, including materials extended or filled with extenders or fillers. Such extenders and fillers can include wood flour, other plastics, etc. Of course, the lower cost inner layer material can be a premium plastic which has been used more sparingly by virtue of the use of a foaming agent to use less of the premium plastic material to fill the space in the middle layer.

FIG. 2 is a side sectional view of a portion of a finished section of lattice 31 produced using a single extruder. As shown herein, the plastic is homogeneous throughout the lattice.

FIG. 3 is a side sectional view of a portion of a finished section of lattice 31 produced using three extruders. As shown in FIG. 3, the sheet is formed of an inner layer 23 and first and second outer layers 21, 22.

FIG. 4A is a close-up perspective view of a portion of an example lattice according to the present invention and showing individual slat-like elements forming a cross-type pattern. Of course, the lattice depicted herein is actually a single, unitary piece that merely has the appearance of having individual slats. Moreover, as depicted in FIG. 4A, the lattice is embossed with a wood grain surface pattern. The appearance of individual slats is effected by having the apparent grain interrupted on one slat where it meets an adjacent transverse slat. By controlling how the grain pattern is interrupted, one can cause the slats to appear to be overlaid, with all of the slats running in one direction appearing to be in the foreground and all of the slats in the opposite direction appearing to be in the background. Also, as shown in FIG. 4B, the grain pattern appearance can be configured to cause the slats to appear to be woven, as depicted.

In addition, as shown in FIG. 4C, the slats can be embossed to such a degree that the front or upper surface of the lattice has a slightly three-dimensional configuration such that some parts thereof stand slightly proud of or taller than other parts, which adds to the visual appearance of the plastic lattice. As shown in this figure, the slats 51, 52 appear to overlay slats 53, 54. Alternatively, the embossing can be configured to create the appearance that the slats are interwoven, such as in a basket-weave style of pattern. Other visual effects can be obtained as desired also.

Heretofore it has not been known to produce a plastic lattice with a three-dimensional appearance (or a three-dimensional front (top) surface) and having a wood grain appearance by way of extrusion, due to the fact that extruded products typically have smoothly-continuous, uninterrupted outer surfaces. As such, in the past known plastic lattice has been injection molded to provide such three-dimensional surface features. However, the novel manufacturing method described herein allows for the production of three-dimensional surface features and wood grain appearance in an extrusion process. This has the benefit of combining the speed and efficiency of an extrusion process with the surface feature intricacy normally found only in molded plastic products. Thus, the novel manufacturing method provides the best of both.

While the invention has been described with reference to preferred and example embodiments, it will be understood by those skilled in the art that a variety of modifications, additions and deletions thereto are within the scope of the invention, as defined by the following claims.

1. An extruded plastic lattice sheet comprising:
a perforated sheet of plastic resin formed from an extruded sheet of plastic resin having been die punched to remove portions of plastic resin leaving a crisscross pattern; and
wherein an outer surface of the perforated sheet is embossed with a wood grain effect.

2. The extruded plastic lattice sheet of claim 1 wherein the outer surface of the perforated sheet is embossed with an appearance of interwoven slats.

3. The extruded plastic lattice sheet of claim 1 wherein the outer surface of the perforated sheet is embossed with an appearance of overlaid slats.

4. The extruded plastic lattice sheet of claim 1 wherein the outer surface of the perforated sheet is embossed with a substantially three-dimensional appearance of criss-cross slats.

5. The extruded plastic lattice sheet of claim 4 wherein the substantially three-dimensional appearance of slats on the outer surface of the perforated sheet comprises some slat-like portions of the plastic lattice sheet standing slightly proud of other slat-like portions of the plastic lattice sheet.

6. The extruded plastic lattice sheet of claim 1 wherein the plastic resin comprises high-density polyethylene.

7. The extruded plastic lattice sheet of claim 1 wherein the perforated sheet comprises an inner layer and first and second outer layers wherein the layers are all formed by extrusion, and wherein the composition of the inner layer is different than the composition of the outer layers.

8. The extruded plastic lattice sheet of claim 7 wherein the inner layer is foamed.

9. The extruded plastic lattice sheet of claim 1 wherein the perforated sheet comprises an inner layer and first and second outer layers, wherein the layers are all formed by extrusion, and wherein the inner layer is made with a lower cost material per volume than the outer layers.

10. The extruded plastic lattice sheet of claim 9 wherein the lower cost material per volume of the inner layer is obtained by foaming or by adding low-cost fillers.

11. A method of manufacturing a plastic lattice component, the method comprising the steps of:
extruding a sheet of plastic resin through a flat sheet die;
cutting the sheet of plastic resin to a desired length;
die punching the sheet of plastic resin to remove some portions of plastic resin, leaving a perforated sheet; and
embossing the cut sheet of plastic resin to impart an appearance of criss-cross plastic slats and a wood grain surface.

12. The method of claim 11 wherein the plastic resin is high-density polyethylene.

13. The method of claim 11 further comprising gathering punched-out resin from the die punching step, grinding the punched-out resin, and recycling the ground resin by incorporating the ground, punched-out resin into resin fed to an extruder to extrude the sheet of plastic.

14. The method of claim 11 wherein the step of extruding plastic resin comprises extruding a multi-layer sheet including an inner layer and first and second outer layers, wherein the layers are all formed by extrusion, and wherein the inner layer is made with a lower cost material per volume than the outer layers.

15. The method of claim 11 wherein an outer surface of the perforated sheet is embossed with a substantially three-dimensional appearance of criss-cross slats.

16. A plastic lattice component manufactured by the method of claim 11.

17. A method of manufacturing a plastic sheet having a lattice-like appearance, the method comprising the steps of:
extruding a sheet of plastic resin comprising a mixture of prime high-density polyethylene resin, recycled high-density polyethylene resin, and an additive through a flat sheet die;
cutting the plastic resin to a desired length;
die punching the sheet of plastic resin to remove diamond-shaped pieces of plastic resin; and
embossing the cut sheet of plastic resin to impart an appearance of raised plastic slats having a wood grain-like pattern thereon.

18. A plastic sheet product manufactured according to the method of claim 17.
